(19) United States
(12) Patent Application Publication
(10) Pub. No.: US 2014/0095427 A1
(43) Pub. Date: Apr. 3, 2014

(54) SEO RESULTS ANALYSIS BASED ON FIRST ORDER DATA

(71) Applicant: Rimm-Kaufman Group, LLC, Seattle, WA (US)

(72) Inventors: Vanessa Fox, Seattle, WA (US); Heather Champion, Seattle, WA (US); Jeremy Wadsack, Seattle, WA (US); Sarah Amandus, Lynnwood, WA (US); Michael Kintzer, Seattle, WA (US)

(73) Assignee: Rimm-Kaufman Group, LLC, Seattle, WA (US)

(21) Appl. No.: 14/043,675

(22) Filed: Oct. 1, 2013

Related U.S. Application Data
(60) Provisional application No. 61/708,606, filed on Oct. 1, 2012.

(51) Int. Cl. G06F 17/30

(52) U.S. Cl. CPC G06F 17/30424
USPC 707/603

(57) ABSTRACT

Search query analytic reports may assist a website operator in understanding web traffic patterns in relation to the website. A search query analytic report may be generated by receiving web search data for a website from multiple data sources and assigning the web search data into multiple website-specific categories of the website. The web search data is then analyzed based on the website-specific categories to generate the search query analytic report. Server status reports may provide details on errors in the indexing of web pages stored on a server that hosts a website. A server status report may be generated by analyzing the server log data to determine web page indexing behaviors of the one or more web crawlers with respect to the web pages stored on the server.

### CROSS REFERENCE TO RELATED APPLICATION

This application claims priority to U.S. Provisional Patent Application No. 61/708,606 to Vanessa Fox, entitled “SEO Results Analysis Based on First Order Data”, filed on Oct. 1, 2012, and incorporated herein by reference.

### BACKGROUND

Website operators are concerned with driving web traffic to their websites through search engines. Often, the number of views and click-throughs that a website receives translate into revenue and profit for the website. There may be many thousands of web search queries that drive web users to a specific website. Web search engines may provide the contents of such web search queries and data related to such web search queries to the website operator of the specific website. However, the website operator of the specific website may encounter difficulties in tracking and parsing such information to understand the truly important web search queries that drove web users to the specific website.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a schematic diagram of an illustrative environment for implementing various embodiments of search query analysis and web server analysis for a website.

FIG. 2 is a schematic diagram of illustrative components of a search query analyzer for analyzing search queries that drive web traffic to a website, and illustrative components of a website analyzer for analyzing web server errors.

FIG. 3 illustrates a first example search query analytic report generated by a search query analyzer that shows category trends.

FIG. 4 illustrates a second example search query analytic report generated by the search data analyzer that shows category ranking, click-through rate, impression, and query count information.

FIG. 5 illustrates a third example search query analytic report generated by the search data analyzer that shows search result positions of a website with respect to a category.

FIG. 6 illustrates a fourth example search query analytic report generated by the search data analyzer for projecting changes due to the modification of a search result position in a category.

FIG. 7 illustrates a fifth example search query analytic report generated by the search data analyzer for projecting changes due to the modification of conversion and revenue information.

FIG. 8 illustrates a sixth example search query analytic report generated by the search data analyzer that shows summary information for a category.

FIG. 9 illustrates a seventh example search query analytic report generated by the search data analyzer that shows the impact of missing keyword data.

FIG. 10 illustrates an eighth example search query analytic report generated by the search data analyzer that shows missing keyword data captured by a search data analyzer.

FIG. 11 illustrates a first example server status report generated by the website analyzer that shows distribution of response status codes.

FIG. 12 illustrates a second example server status report generated by the website analyzer that selectively shows response status codes for multiple search engines.

FIG. 13 illustrates a third example server status report generated by the website analyzer that shows the distribution of response status codes over a period of time.

FIG. 14 illustrates a fourth example server status report generated by the website analyzer that shows response status code information for web page directories of a website.

FIG. 15 illustrates a fifth example server status report generated by the website analyzer that selectively shows response status codes according to search engine and code type.

FIG. 16 illustrates a sixth example server status report generated by the website analyzer that shows errors with respect to the return of response status codes.

FIG. 17 illustrates a seventh example server status report generated by the website analyzer that shows web links which individually return multiple response status codes.

FIG. 18 illustrates a block diagram that illustrates an eighth example server status report generated by the website analyzer that facilitates the detection of data scrappers.

FIG. 19 illustrates a ninth example server status report generated by the website analyzer that shows the distribution of parameters and parameter values of web pages on a website.

FIG. 20 illustrates a tenth example server status report generated by the website analyzer that supplements server error information with website analytics data.

FIG. 21 illustrates an eleventh example server status report generated by the website analyzer that verifies server error information with website analytics data.

FIG. 22 is a flow diagram of an illustrative process for providing a search query analytic report based on web search data from multiple data sources.

FIG. 23 is a flow diagram of an illustrative process for providing a server status report based on information on website visits by search engine web crawlers.

### DETAILED DESCRIPTION

### Overview

The disclosure is directed to architectures and techniques for performing the analysis of search queries that drive traffic to a website and the analysis of web crawl errors. In the analysis of search queries that drive traffic to a website, the source of data for performing such analysis may be obtained from one or more search engines. A search engine may provide web analytics data, webmaster data, and keyword research data. The web analytics data and webmaster data may be website-specific. This means that the web analytic data and webmaster data of a particular website are only relevant to the particular website. However, the keyword research data may apply to an aggregate number of websites on the World Wide Web, referred to herein as “the web”. The web analytics data may provide statistics about traffic, traffic sources, conversions, etc., for a website. The webmaster data may include information related to the indexing and visibility of a website, such as total visitor traffic of the website, search queries that brought traffic to the website, click-through rates of search queries, and other related information. The keyword research data that is generated by a search engine may be generic data that provide information on search results generated by search queries.

Based on these multiple sources of search query information as provided by the one or more search engines, a search query analyzer may classify the search queries and related information for a website using categories. The categories may be developed using factors such as the business objectives of the website operator that operates the website, the business processes and practices of the website operator, as well as other data regarding the operations and strategies of the website operator. The search query analyzer may use the search queries and related information as classified into the categories to generate query analytic reports. In various embodiments, the search query analytic reports may assist the website operator in understanding web traffic patterns in relation to the website, as well as develop effective strategies in driving web traffic through improved correlations between the content of the website and the search queries.

In the analysis of web crawl errors, a website analyzer may analyze the server logs of a website. The server logs of the website may indicate errors that are encountered by the web crawlers, i.e., bots, of search engines as the web crawlers index the web pages of the website. Since the search result positions of a website in response to search queries are dependent on the proper indexing of the web pages in the first place, the inability of the web crawlers to properly index web pages may adversely impact the search result positions of the website.

In various embodiments, the website analyzer may generate server status reports that assist in the diagnoses and isolation of problems with respect to the web pages of the website. For example, the server status reports may identify trends in the amount of errors over time, reveal particular sections of a website (e.g., one or more particular web pages) that are responsible for the errors, pinpoint other causes such as slow server response time, incorrect server configuration parameters, and/or other information.

### Illustrative System Architecture

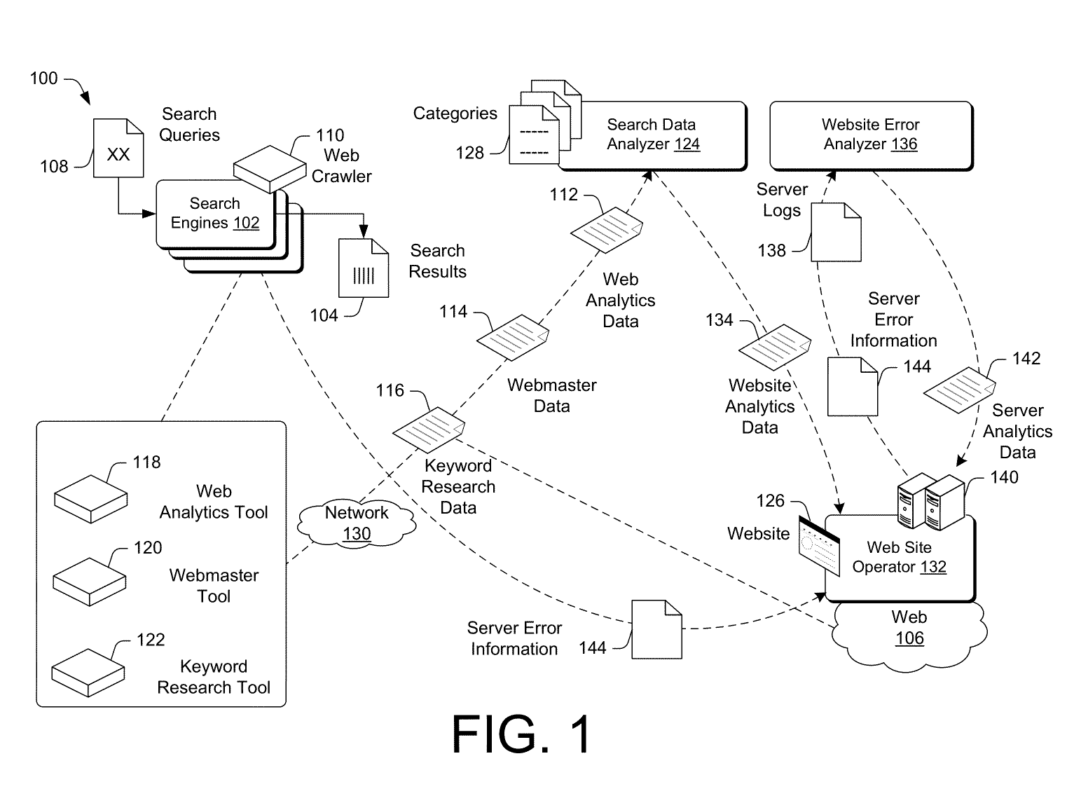

FIG. 1 is a schematic diagram of an illustrative environment 100 for implementing various embodiments of search query analysis and web server analysis for a website. The illustrative environment 100 may include one or more search engines 102. Each of the search engines 102 is a software application designed to return search results 104 from the web 106 in response to search queries 108. Each of the search queries 108 may include one or more keywords and/or other data such as images, time/date information, geographic information, and so forth; in the same or other embodiments, the search queries may be voice queries that are converted to one or more keywords. The search results may be presented in ranked order on search engine results pages (SERPs). The search results may include web pages, images, and/or other types of data that are retrieved from websites. In order to return search results that are relevant to search queries, a search engine may use a web crawler, such as the web crawler 110, to index web pages on the web by systematically browsing the web pages.

In addition to providing search results to search queries, each of the search engines 102 may also provide data that are related to the search results and the search queries. A search engine may provide web analytics data 112, webmaster data 114, and/or keyword research data 116. Such data may be generated by analytics tools (e.g., software applications) that are built into the search. For example, each of the search engines 102 may include a web analytics tool 118 that provides web analytics data 112, a webmaster tool 120 that provides webmaster data 114, and/or a keyword research tool 122 that provides keyword research data 116.

The web analytics data 112 and webmaster data 114 may be website-specific. This means that the web analytic data and webmaster data of a particular website, such as the website 126, are only relevant to the particular website. However, the keyword research data 116 may apply to an aggregate number of websites on the web. The web analytics data 112 may provide statistics about traffic, traffic sources, conversions, etc., for each website. For example, the web analytic data 112 for a particular website may provide the one or more keywords of each search query that resulted in a web user visiting a particular website in a particular time period. For example, the web analytics tool 118 for a search engine may provide the information “searchengine.com/?q=used cars” to a website, indicating that a search query containing the keywords “used cars” lead to the website being returned as a search result. In one instance, the web analytics data may be provided by the Website Analytics Tool operated by Google, Inc. of Mountain View, Calif.

The webmaster data 114 may include information related to the indexing and visibility of a website, such as total visitor traffic of the website, search queries that brought traffic to the website, click-through rates of search queries, and other related information. For example, the webmaster data 114 may show that, for a search query with one or more keywords (e.g., “reliable used car”) that resulted in a click-through to a website, the particular search result position of the website. Search result position refers to the hierarchical position of the web page as displayed in the one or more search result pages generated by a search engine for a specific search query. In one instance, the webmaster data may be provided by the Webmaster Central Tool Set operated by Google, Inc.

The keyword research data 116 that is generated by the keyword research tool 122 may be generic data that provide information on search results generated by search queries. For example, the keyword research data may indicate for a particular search query, the number of people that used the particular search query in a particular time period, whether a particular website was returned as a search result (since the keyword research data is not website-specific), and if applicable, the number of times that the particular website was returned as the search result. Various search engines provide keyword research data. These search engines may include the Google search engine operated by Google, Inc., and the Bing search engine operated by the Microsoft Corp. of Redmond, Wash.

Based on the web analytics data 112, the webmaster data 114, and/or the keyword research data 116 provided by the one or more search engines 102, a search data analyzer 124 may assign the search queries and their related information for a website using categories 128. For example, the website may be the website 126. The search data analyzer 124 may obtain the web analytics data 112, the webmaster data 114, and/or the keyword research data 116 from the search engines 102 via a network 130. The network 130 may be a local area network (“LAN”), a larger network such as a wide area network (“WAN”), or a collection of networks, such as the Internet.

The categories 128 for the website 126 may be developed using factors such as the business objectives of a website operator 132 who operates the website 126, the business processes and practices of the website operator 132, as well as other data regarding the operations and strategies of the website operator 132. In some embodiments, the categories 128 may be developed by human research analysts based on the multiple factors. The search data analyzer 124 may use the relevant search queries as classified into the categories 128 to generate website analytics data 134. The website analytics data 134 may be presented to the website operator 132 as search query analytic reports. In various embodiments, the search query analytic reports may assist the website operator 132 in understanding web traffic patterns in relation to the website 126 and develop effective strategies in driving web traffic through improved correlations between the content of the website 126 and search queries.

For example, a search query analytic report may show the search result positions of a website with respect to keywords that are in multiple categories of search queries. The search query analytic report may provide information pertaining to the number of impressions, click-through rates, web traffic, and/or other data that are associated with the search result positions. In another example, a search query analytic report may project the expected increase in click-through rate, traffic volume, conversion rate, and/or revenue when the search result position of a website is improved with respect to a particular set of keywords in a category.

A website analyzer 136 may analyze the server logs 138 of the one or more servers 140 that host a website, such as the website 126. The server logs for the servers 140 may indicate errors that are encountered by the web crawlers of search engines 102 as the web crawlers index the web pages of the website. Since the search result positions of a website in response to search queries are dependent on the proper indexing of the web pages in the first place, the inability of the web crawlers to properly index web pages may adversely impact the search result positions of the website.

In various embodiments, the website analyzer 136 may generate server analytic data 142 based on the information in the server logs, website analytics data, and/or server error information 144 regarding the servers 140. The server error information 144 may be provided by the search engines. The server analytics data 142 may be in the form of server status reports that assist in the diagnoses and isolation of problems with respect to the web pages of the website 126. For example, the server status reports may identify trends in the amount of errors over time, reveal particular sections of a website (e.g., one or more particular web pages) that are responsible for the errors, pinpoint other causes such as slow server response time, incorrect server configuration parameters, and/or so forth. A report may also indicate differences in the amount of errors encountered by different search engines.

In various instances, the reports that are generated by the website analyzer 136 may provide more detail (e.g., type, location, cause) than is provided by the error reports that are made available to the website operator of the website by the one or more search engines 102. Accordingly, the reports may serve to supplement the server error information revealed by the one or more search engines 102.

### Example Server Modules

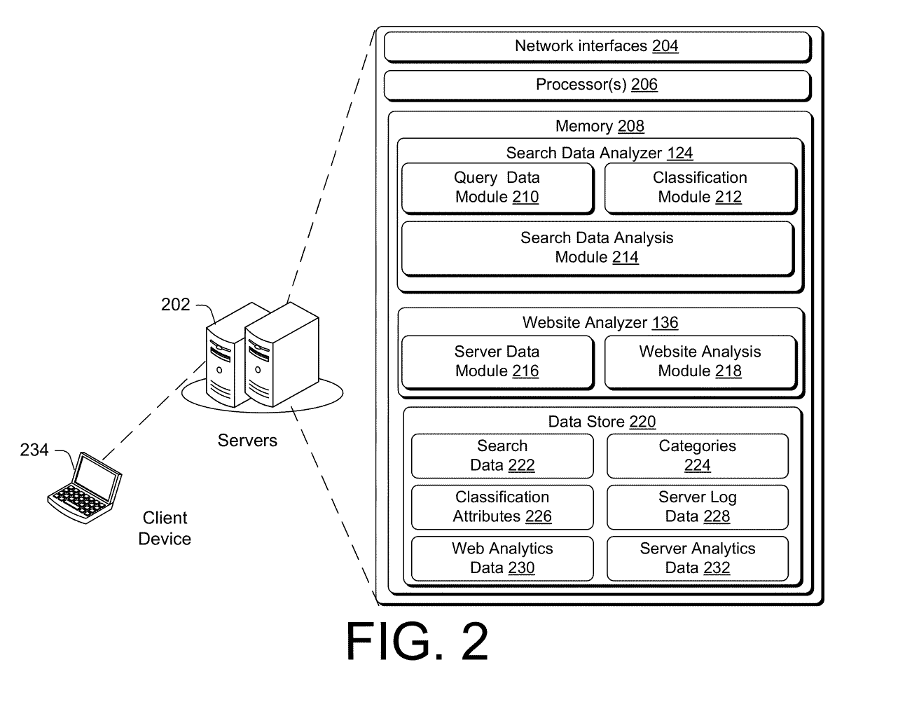

FIG. 2 is a schematic diagram of illustrative components of a search data analyzer 124 for analyzing search queries that drive web traffic to a website, and illustrative components of a website analyzer 136 for analyzing web server errors. The analyzers 124 and 136 may be implemented by the one or more servers 202. The one or more servers 202 may be equipped with network interfaces 204, processor(s) 206, and memory 208. The network interfaces 204 may include wireless and/or wireless communication interface components that enable the servers 202 to transmit and receive data via a network. In various embodiments, the wireless interface component may include, but is not limited to cellular, Wi-Fi, Ultra-wideband (UWB), Bluetooth, satellite transmissions, and/or so forth. The wired interface component may include a direct input/output (I/O) interface, such as an Ethernet interface, a serial interface, a Universal Serial Bus (USB) interface, and/or so forth.

The memory 208 may include computer-readable media. The computer-readable media may include non-transitory computer-readable storage media, which may include hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of storage media suitable for storing electronic instructions. In addition, in some embodiments the computer-readable media may include a transitory computer-readable signal (in compressed or uncompressed form). Examples of computer-readable signals, whether modulated using a carrier or not, include, but are not limited to, signals that a computer system hosting or running a computer program can be configured to access, including signals downloaded through the Internet or other networks.

The search data analyzer 124 may include a query data module 210, a classification module 212, and a search data analysis module 214. The query data module 210 may receive the web analytics data 112, the webmaster data 114, and/or the keyword research data 116 from a server of the one or more search engines 102. The query data module 210 may use the network interface 204 to communicate with the one or more search engines 102. The query data module 210 may periodically pull the data from a server, receive push of the data from the server, or obtain the data using a combination of pull and push data communication with the server.

The classification module 212 may assign the search queries and associated information that are relevant for each website according to a set of corresponding categories. The search data analysis module 214 may obtain the search queries and the relevant information for each website from the web analytics data 112, the webmaster data 114, and/or the keyword research data 116. The search queries and the associated information may be relevant to a website when one or more web pages of the website are retrieved as search results for the search queries. The associated information for a search query may include a number of impressions of the website that resulted from the search query, a number of click-throughs to the website that resulted from the search query, a number of conversions that occurred at the website as a result of the search query, search result position of the website in relation to the search query, and/or so forth. Each website may have a custom tailored set of categories. For example, the categories 128 for the website 126 may be developed using factors such as the business objectives of a website operator 132, the business processes and practices of the website operator 132, as well as other data regarding the operations and strategies of the website operator 132.

Each of the categories for a website may be assigned a unique classification attribute, such as a regular expression, that represents the category. A regular expression may include a string of characters and/or operators that form a search pattern. Accordingly, the classification module 212 may use multiple regular expressions to assign search queries and associated information that are relevant to a website into a set of categories. For example, the categories for an online outdoor gear retailer may include categories such as “repellents,” “running,” “snow sports,” “summer,” “travel,” “water purification,” “water sports,” etc. In such an example, the classification module 212 may assign multiple search queries into the “repellents” category. For instance, the multiple search queries may include queries with keywords such as “mosquito spray,” “buy repellent,” “insect spray,” “kill bugs,” and “get rid of bugs.”

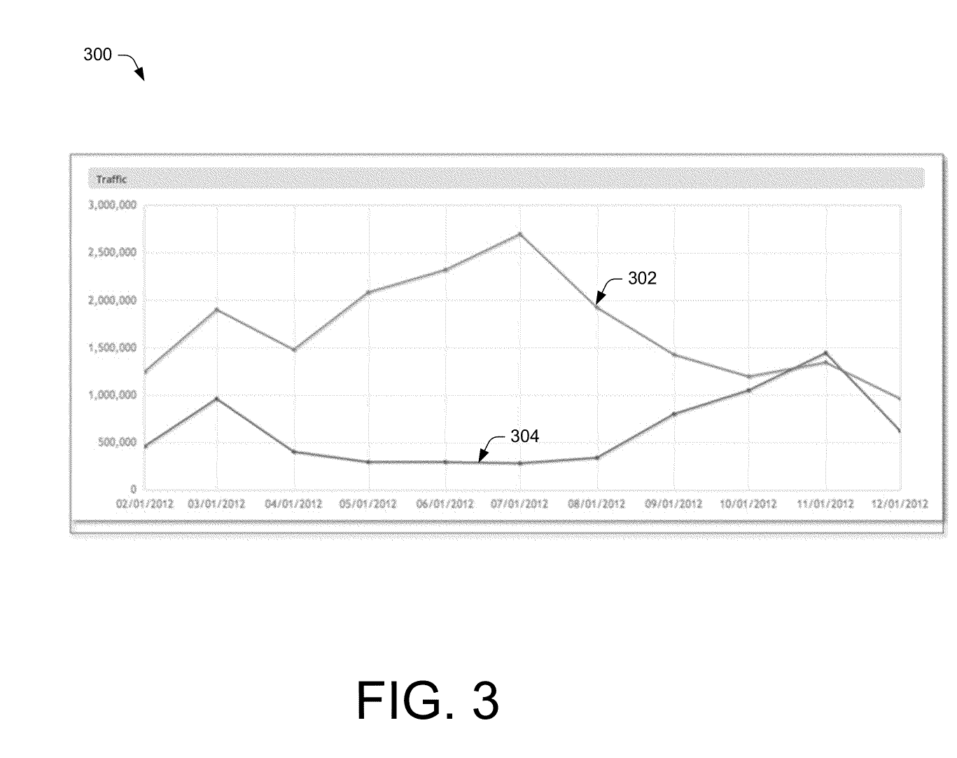

The search data analysis module 214 may generate the website analytics data for each website based on the classified search queries and their associated information. In one instance, the search data analysis module 214 may generate the website analytics data 134 for the website 126. The website analytics data 134 that are generated for each website may be in the form of search query analytic reports. For example, a search query analytic report may show the search result positions of a website with respect to keywords that are in the multiple categories of search queries. The search query analytic report may provide information pertaining to the number of impressions, click-through rates, web traffic, and/or other data that are associated with the search result positions. In another example, a search query analytic report may project the expected increase in click-through rate, traffic, conversion rate, and/or revenue when the search result position of a website is improved with respect to a particular set of keywords in a category. The search data analysis module 214 may generate various reports based on user inputs of different display parameters and/or user requests. Likewise, the search data analysis module 214 may perform multiple data projections based on user inputs of different projection parameters. In some instances, the reports and data projections may also be generated automatically by the search data analysis module 214. Further details regarding the types of reports and/or data projections that may be generated by the search data analysis module 214 are described below in FIGS. 3-10.

The website analyzer 136 may include a server data module 216 and a website analysis module 218. The server data module 216 may receive server logs from servers that host different websites. For example, the server data module 216 may receive the server logs 138 from the servers 140 of the website 126. The server logs may include entries that pertain to web crawler visits, in which each entry may shows an identifier of a web crawler, the uniform resource locator (URL) of the web page visited by the web crawler, the time and date of visit, a hypertext transfer protocol (HTTP) response status code that is returned by a server regarding the visit. The response status code may indicate a successful visit by the web crawler (e.g., response status codes 200, 301, 304, etc.) or that an error occurred during the visit attempt (e.g., response status codes 402, 403, 404, 50x). A successful visit by the web crawler to a web page may indicate an indexing of the web page by the web crawler, while an error may indicate a failure to index the web page. Other information in each entry may include the HTTP method, the referring URL, the originating port of the request, IP address of the requester, user agent of the requestor, and host name of the requestor. The server data module 216 may also receive server error information, such as the server error information 144, concerning websites from the search engine 102. The server data module 216 may use the network interface 204 to communicate with the servers that host a website and servers of the one or more search engines 102. Server data module 216 may periodically pull the data from a server, receive push of the data from a server, or obtain the data using a combination of pull and push data communication with a server.

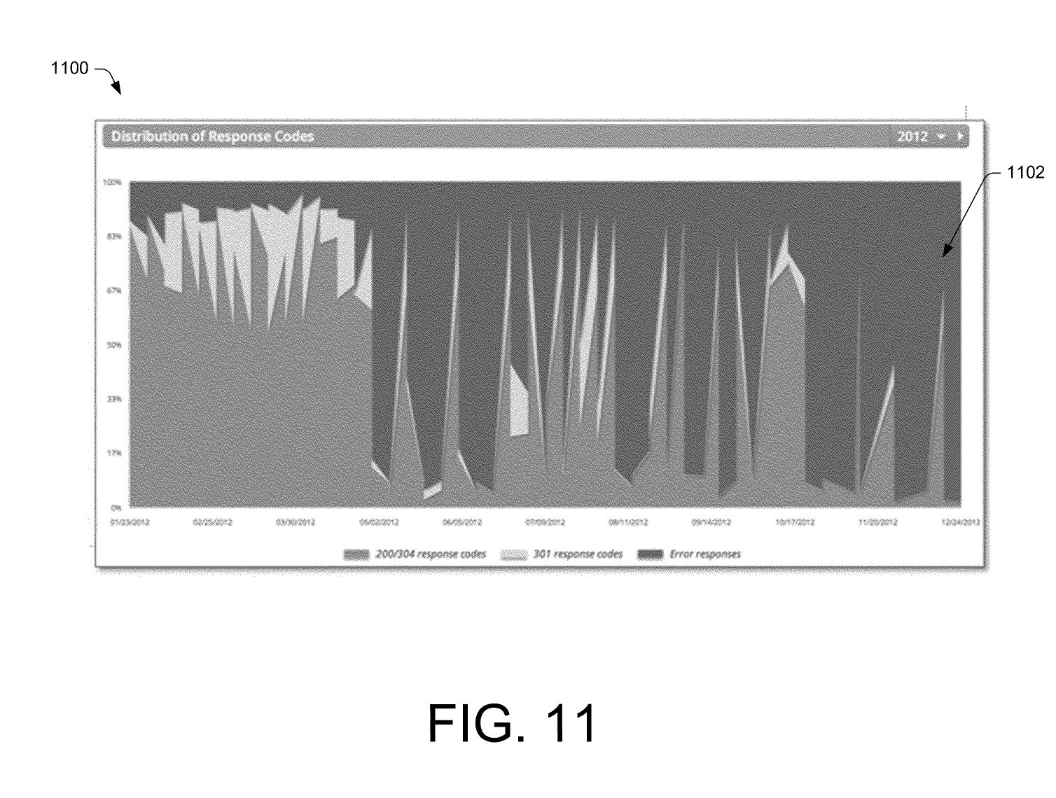

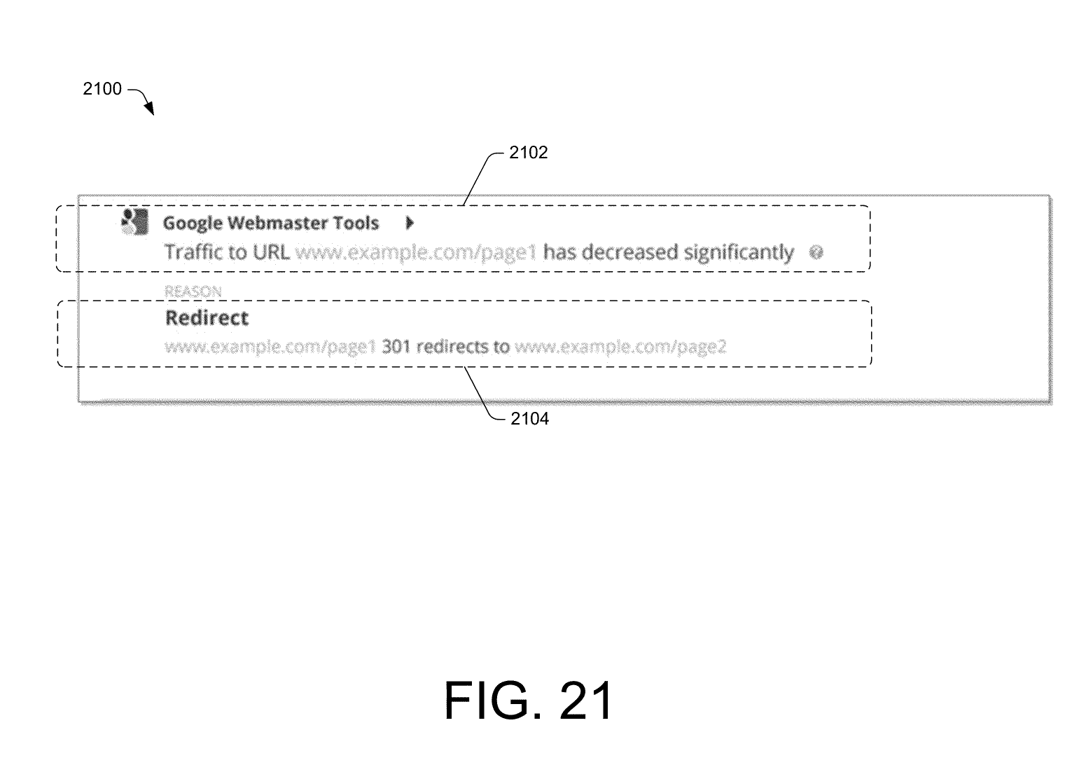

The website analysis module 218 may generate server analytics data for multiple websites based on server log data of the servers for those websites, web analytics data generated by the search data analyzer 124, and/or the server error information. For example, the website analysis module 218 may generate server analytics data 142 with respect to the website 126 based on the information in the server logs 138 and/or server error information from one or more of the search engines 102. The server analytics data 142 may be in the form of server status reports that assist in the diagnostic and isolation of problems with respect to the web pages of a website. Specific server status reports may be generated automatically or according to user inputs of display parameters and/or user requests. For example, the reports may identify trends in the amount of errors over time, reveal particular sections of a website (e.g., one or more particular web pages) that are responsible for the errors, pinpoint other causes such as slow server response time, incorrect server configuration parameters, and/or so forth. A report may also indicate difference in the amount of errors encountered by different search engines. Further details regarding the types of reports that are generated by the website analysis module 218 are described below in FIGS. 11-21.

The data store 220 may store the data that are used by the search data analyzer 124 and the website analyzer 136. In various embodiments, the data store 220 may store search data 222, categories 224, classification attributes 226, server log data 228, web analytics data 230, server analytics data 232, and so forth. The search data 222 may include search queries and associated information that are collected for multiple websites. The categories 224 may include categories that are individually developed for the multiple websites. The classification attributes 226 may include attributes that enable the classification of search queries and their related information into the categories of each website. The server log data 228 may include server log data from servers that host the multiple websites. Further, the web analytics data 230 and the server analytics data 232 may include data that are generated for the multiple websites. In various embodiments, website-specific data that are stored in the data store 220 may be organized and stored in website-specific folders and/or directories.

In some embodiments, each of the search data analyzer 124 and the website analyzer 136 may include a user interface component that enables an administrator to interact with the respective analyzer using a user interface. The user interface may include a data output device (e.g., visual display, audio speakers), and one or more data input devices. The data input devices may include, but are not limited to, combinations of one or more of keypads, keyboards, mouse devices, touch screens, microphones, speech recognition packages, and any other suitable devices or other electronic/software selection methods. For example, the administrator may use the user interface component to edit the various databases, view previously generate reports, input or modify display and projection parameters, select search query or server logs from particular time periods for analysis, and/or so forth.

The search data analyzer 124 and the website analyzer 136 may provide the web analytics data 230 and the server analytics data 232 to various client devices, such as the client device 234. Client devices may a mobile communication device, a smart phone, a portable computer, a tablet computer, a desktop computer, a slate computer, or any other electronic device that is equipped with network communication components to receive and transmit data, data processing components to process data, and user interfaces to receive data from and present data to a user.

The client devices may be operated by various users, such as website owners. The web analytics data 230 and the server analytics data 232 may be presented in digital form (e.g., web page, application interface page, etc.) to a user via a web browser and/or one or more custom applications on a client device. In turn, a user of a client device may use the web browser and/or the one or more custom applications to provide user input to the search data analyzer 124 and the website analyzer 136. These user inputs may enable a user of a client device to request various reports, customize the outputs of the reports, input or modify display and projection parameters for the reports, select and view reports for particular time periods, and/or so forth.

### Example Reports

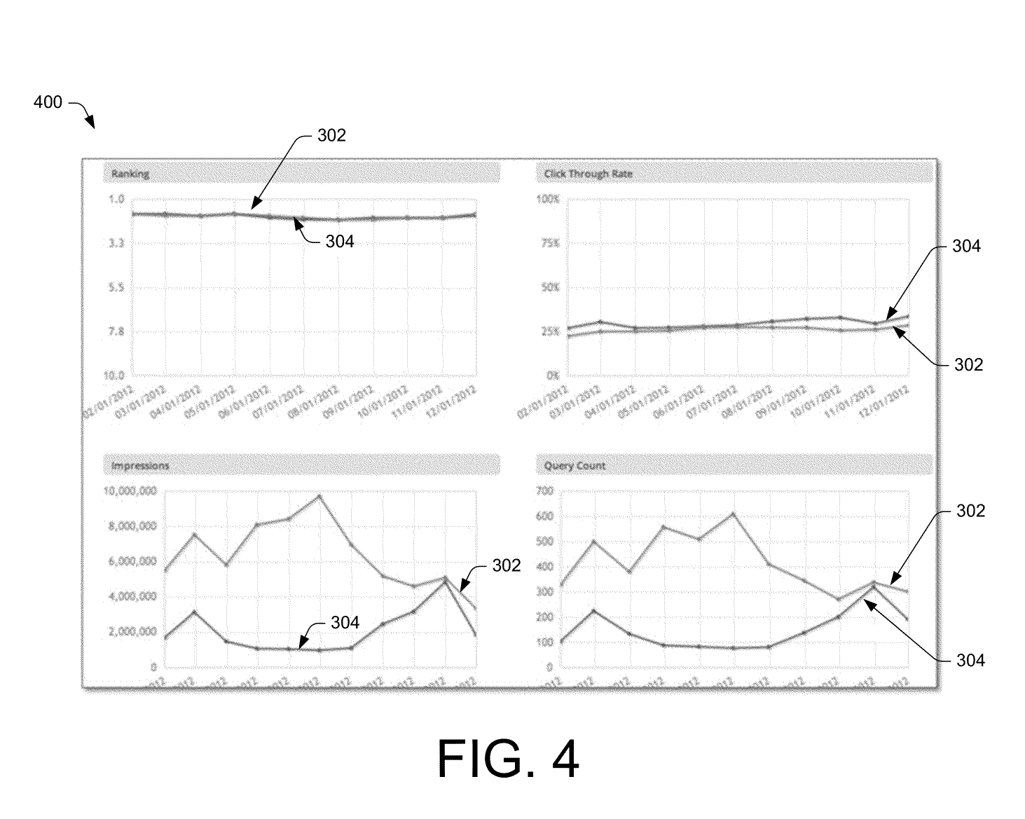

FIG. 3 illustrates an example search query analytic report 300 generated by the search data analyzer 124 for a website. The report 300 may display traffic volume trend lines for a category 302 and a category 304. As shown, the traffic volume for category 302 peaked in July and then declined. Likewise, traffic volume for category 304 peaked in November and then declined. The search data analysis module 214 of the search data analyzer 124 may generate the report 300 by assigning the keywords of search queries into categories, then displaying traffic volume for each category. There may be numerous reasons for the traffic drop for each of the categories, such as seasonality (fewer people searching), a loss of ranking on a search engine results, page, and so forth. In this case, the actual reason for the drop in the traffic volume for the category 306 may be discerned based on the example search query analytic report 400 shown in FIG. 4.

FIG. 4 illustrates an example search query analytic report 400 generated by the search data analyzer 124. The search query analytic report 400 is generated for the same time period as the search query analytic report 300, as well as for the same categories 302 and 304. The search data analysis module 214 of the search data analyzer 124 may generate the report 400 by assigning the keywords of search queries into the categories, then display a category ranking, a click-through rate, a number of impressions (search volume), and a number of queries (query count) for each category as trend lines over a time period. Thus, as shown in the search query analytic report 400, ranking did not decline for each of the category 302 and the category 304. However, impressions and query count have a similar pattern to traffic volume for each category. Accordingly, the analysis of the search query analytic report 300 and the search query analytic report 400 may lead to a conclusion that seasonality is at work for the declines. Thus, the category 302 includes search queries that are popular in the summer, while the category 304 includes search queries that are popular in the fall. Further evidence that seasonality is at work is in the ranking trend lines for each category, which showed that the ranking of the categories 302 and 304 are unchanged through the year.

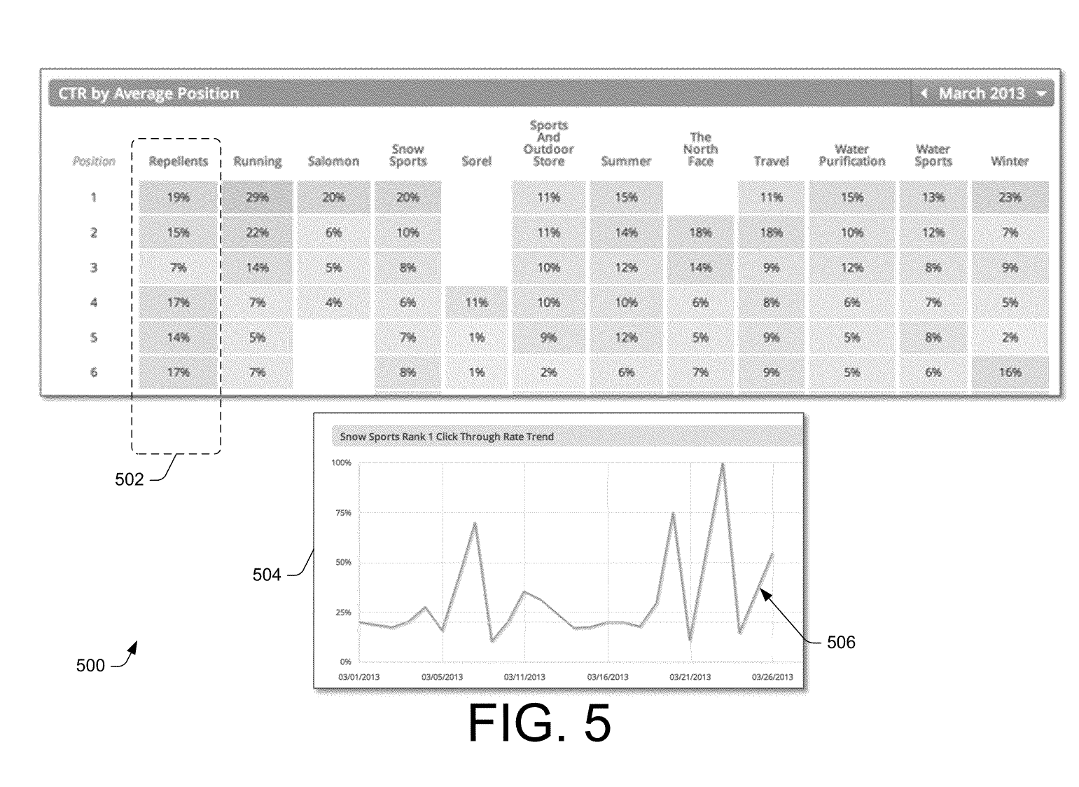

FIG. 5 illustrates an example search query analytic report 500 generated by the search data analyzer 124. The search data analyzer 124 may calculate the click-through rate (CTR) for each of the multiple search result positions of a particular website in the multiple categories. For example, for the “repellents” category 502 shown in the report 500, the particular website may have achieved the following positions in response to specific keywords at a particular point in time:

| Keywords | Search Result Position for Keywords | CTR |
|---|---|---|
| “mosquito spray” | 1 | 20% |
| “buy repellent” | 1 | 18% |
| “insect spray” | 2 | 16% |
| “kill bug” | 2 | 14% |
| “get rid of bugs” | 3 | 7% |
| . . . | . . . | . . . |

Thus, in the example, the particular website was returned as a first ranked search result, i.e., search result position No. 1, by a search engine in response to search queries that contain the keywords “mosquito spray” and “buy repellent.” Other data obtained by the search data analyzer 124 may indicate that the click-through rates for when the particular website achieved search result position No. 1 are respectively 20% for “mosquito spray” search queries and 18% for “buy repellent” search queries. Thus, as shown in the report 500, the average click-through rate for all the search queries in which the particular website achieved the search result position No. 1 is 19%.

Further in the example, the particular website was returned as a second ranked search result, i.e., search result position No. 2, by the search engine in response to search queries that contain the keywords “insect spray” and “kill bug.” Other data obtained by the search data analyzer 124 may indicate that the click-through rates for when the particular website achieved search result position No. 2 are respectively 16% for the “insect spray” search queries and 14% for “kill bug” search queries. Thus, as further shown in the report 500, the average click-through rate for all the search queries in which the particular website achieved the search result position No. 2 is 15%.

Lastly, the particular website was returned as a third ranked search result, i.e., search result position No. 3, by the search engine in response to search queries that contain the keywords “get rid of bugs.” Other data obtained by the search data analyzer 124 may indicate that the click-through rate for when the particular website achieved search result position No. 3 is 7% for the “get rid of bugs” search queries. Since in this example the particular website did not achieve search result position No. 3 with respect to other search queries, the click-through rate is 7%.

Accordingly, by applying such analysis, the search data analyzer 124 may calculate the click-through rates for the search result positions of the particular website with respect to search queries that are in the multiple categories, and display them in the report 500. These categories may include “running,” “snow sports,” “summer,” “travel,” and so forth. Further, as shown in the report portion 504, the click-through rate for a specific search result position achieved by the website in a particular category may be tracked over time to generate a trend line 506. Such trend data may enable a website operator to track click-through rate changes over time to determine return on enhancement that improves search result display (e.g., rich snippets and title changes). The website operator may also use the click-through rate to forecast market opportunities and potential search engine optimization (SEO) impact.

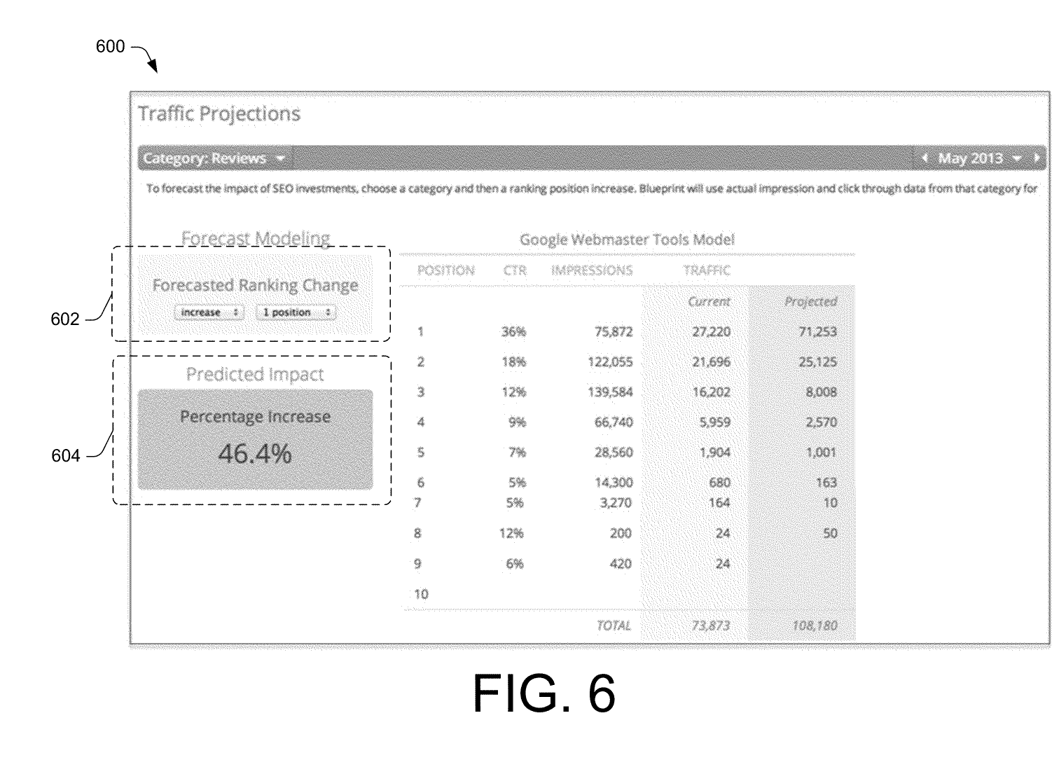

FIG. 6 illustrates an example search query analytic report 600 generated by the search data analyzer 124. The report 600 may provide user input controls 602 that enable a website operator to project increases or decrease in visitor traffic volume to a website based on an increase or decrease, i.e., change, in a search result position of the website in a category. The projected increase or decrease in visitor traffic may be displayed in the report portion 604. Other values that may be projected based on the change in the search result position of the website in a category may include average click-through rate, a number of conversions, and revenue per conversion. In some instances, the search data analyzer 124 may further take into account the click-through rate, the number of conversions, and the revenue per conversion associated with the change in the search result position to recommend one or more categories to invest in for the greatest ROI.

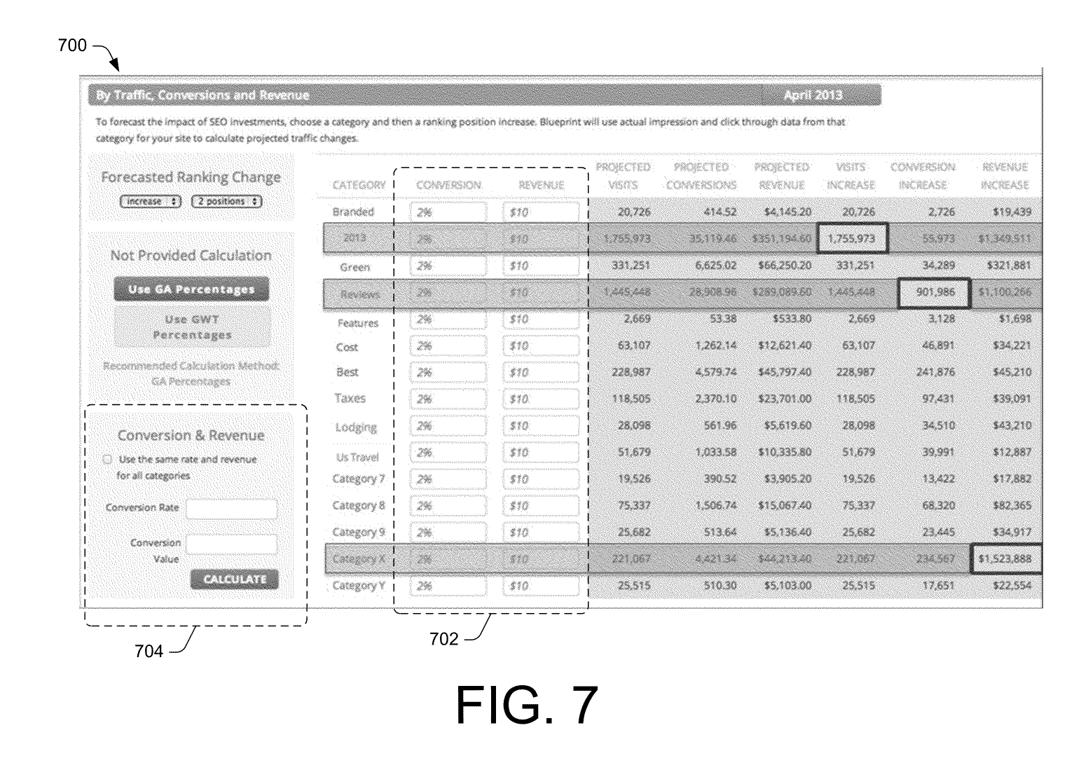

FIG. 7 illustrates an example search query analytic report 700 generated by the search data analyzer 124. The report 700 may provide user input controls 702 and 704 that enable a website operator to generate predictions for the multiple categories in which search queries are classified for a website. In various embodiments, the user input controls 702 and 704 may enable the website operator to manually input conversion and revenue data. In turn, the search data analyzer 124 may calculate changes in the number of visits, conversions, revenue, and/or so forth. In some embodiments, the search data analyzer 124 may also obtain the conversion and revenue data from the web analytics tool of a search engine.

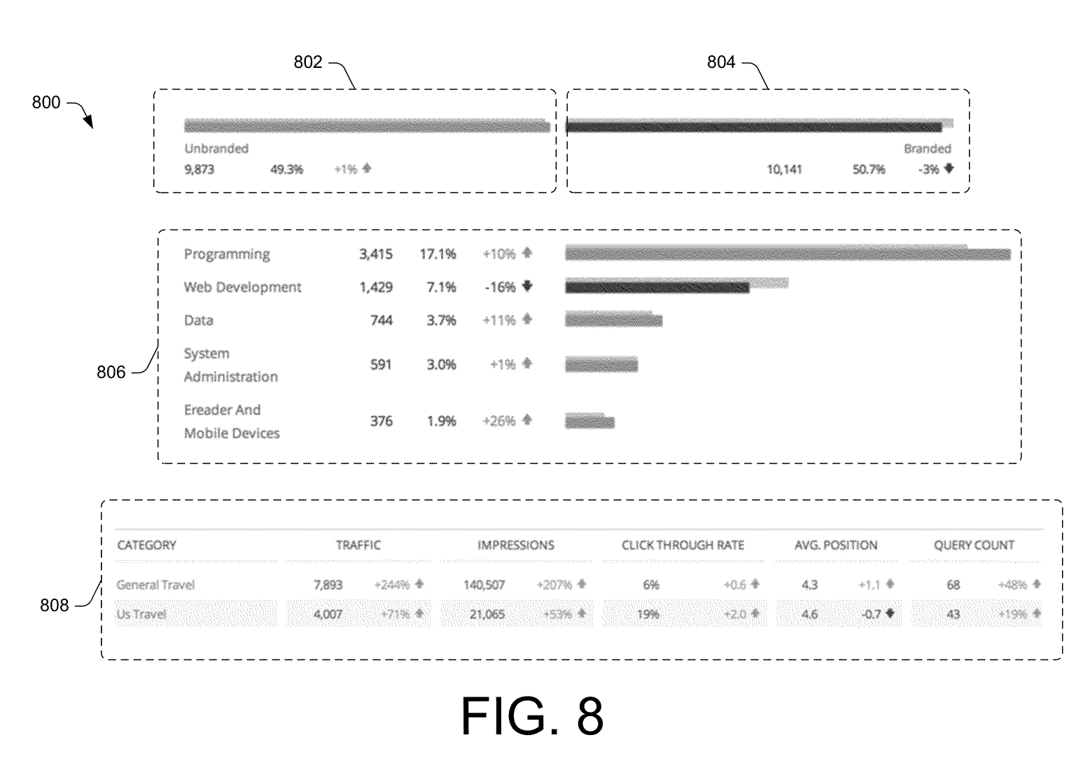

FIG. 8 illustrates an example search query analytic report 800 generated by the search data analyzer 124. The report 800 may provide summary information that pertains to the search queries that are classified into the categories of a website. For example, the report 800 may show a category 802 in which visitor traffic has increased and a category 804 in which visitor traffic has decreased, as well as the traffic trends for other categories 806. The report 800 may also include a summary portion 808 that summaries visitor traffic volume, number of impressions, click-through rates, average positions, and query count information for multiple categories. In this way, the summary portion 808 my enable a website operator to tell at a glance whether visitor traffic changes are due to changes in search volume, click-through rate, or website ranking

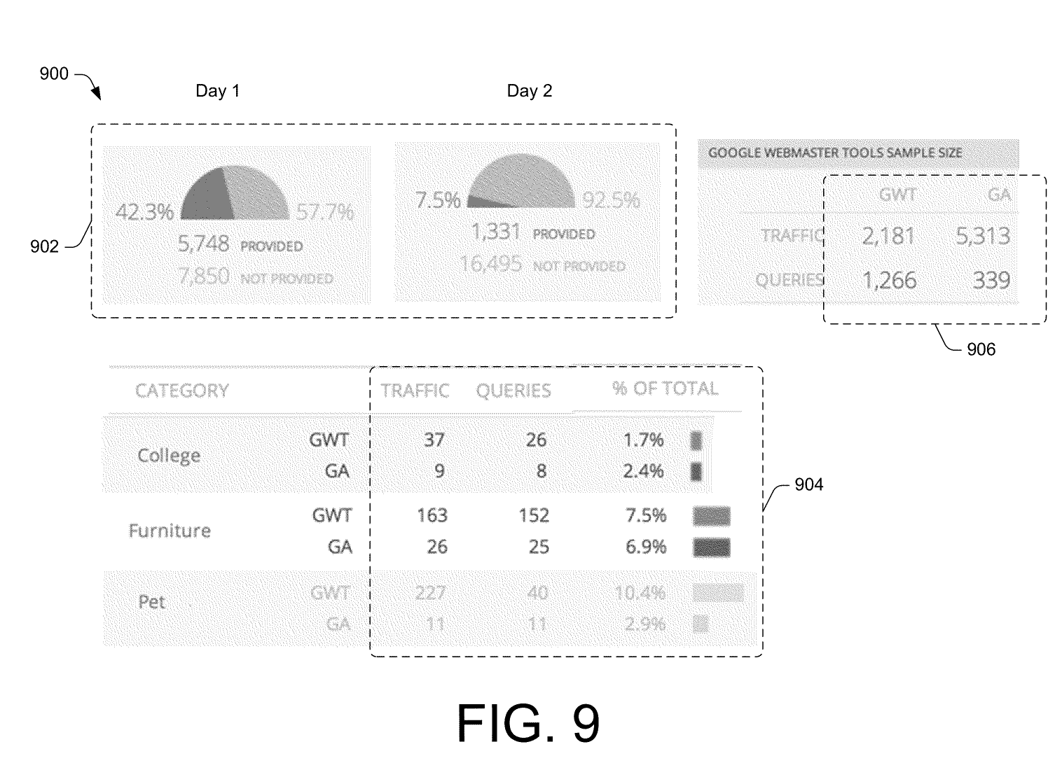

FIG. 9 illustrates an example search query analytic report 900 generated by the search data analyzer 124. In some instances, a web analytics tool of a search engine, such as the web analytics tool 118, may fail to provide the one or more keywords of relevant search queries that resulted in a web user viewing or visiting a particular website. For example, the web analytics tool 118 may sometimes provide “searchengine.com/?q=null” to a website, or otherwise fails to provide the keyword information consistently. Such failure may be due to server errors or privacy policies implemented on the search engine servers. In such instances, a website operator may lose information on effective keywords that drive visitor traffic to a website.

The search data analyzer 124 may extrapolate the one or more keywords of each search query that resulted in a web user viewing or visiting a particular website based on other sources of information. The other sources of information may include the webmaster data 114 and the keyword research data 116. In various embodiments, the search data analysis module 214 of the search data analyzer 124 may use a pattern matching algorithm to extrapolate the missing keywords from the other sources of information. Accordingly, the search data analyzer 124 may generate a report that display the percentage of keywords or the number of keywords that a web analytics tool failed to provide in a particular timer period, as shown in the report portion 902. Alternatively or concurrently, the search data analyzer 124 may also calculate discrepancies in the actual visitor traffic volume and/or actual number of queries (viewings) versus the visitor traffic volume and number of queries reported by the web analytics tool. Once again, the discrepancies may be due to the failure of the web analytics tool to provide keyword data. The report 900 may show such discrepancies in display portions 904 and 906, in which “GA” represents the data from the web analytics tool, and “GWT” represents the data from the search data analyzer 124. In additional embodiments, this means that any data projection for forecasting purposes may be performed using the data obtained by the search data analyzer 124 that is more complete, rather than the data reported by the web analytics tool.

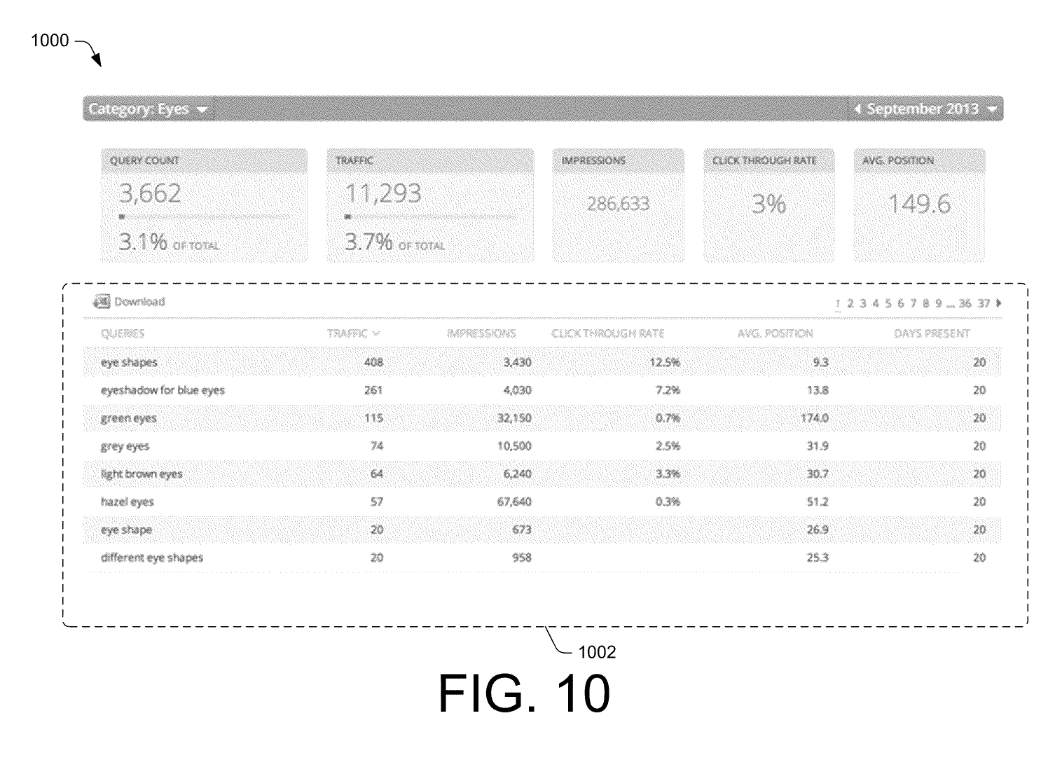

FIG. 10 illustrates an example search query analytic report 1000 generated by the search data analyzer 124. As described with respect to FIG. 9, the web analytics tool of a search engine may fail to provide the one or more keywords of search queries that resulted in a web user visiting a particular website. However, the search data analyzer 124, using the techniques described with respect to FIG. 9, may be able to surface the otherwise inaccessible keywords and provide details on them. For example, the otherwise inaccessible keywords and details may be displayed in the report portion 1002.

FIG. 11 illustrates an example server status report 1100 generated by the website analyzer 136. The report 1100 may show a graph that indicates percentage of a search engine's crawls that resulted in indexable web pages over a period time. As indicated by the area 1102 of the graph that corresponds to “error responses,” the one or more servers that host a website begin to cause a web crawler of the search engine to experience significant errors in the latter half of the year. Further, due to the significance of the error, fixing the cause of the errors may be a high priority.

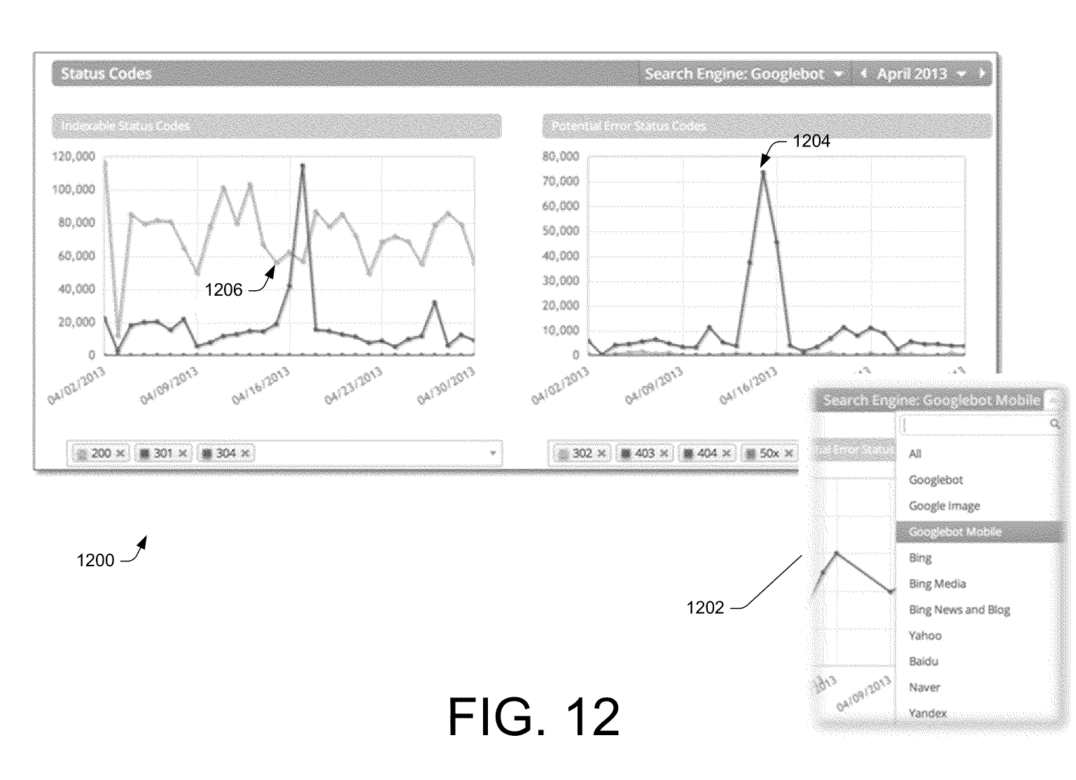

FIG. 12 illustrates an example server status report 1200 generated by the website analyzer 136. The report 1200 includes user input controls 1202 that enables a website operator to view web crawler error data of a website for selective search engines. For example, the website operator may select a web crawler from among web crawlers that include Googlebot, Google Image, Bing, Bing Media, Baidu, etc. In this way, the report 1200 may indicate the compatibilities of the web pages of the website with the web crawlers belonging to the multiple search engines. Alternatively, the website operator may use the user input controls 1202 to select the aggregate web crawler error data for viewing. The report 1200 may also provide trend lines that enable the comparison of indexable response status codes to error response status codes over the same time period. For example, a spike 1204 in a particular type of web crawler error status code (e.g., response status code 404) may correspond temporally to a drop 1206 in another type of web crawler indexable status code (e.g., response status code 200).

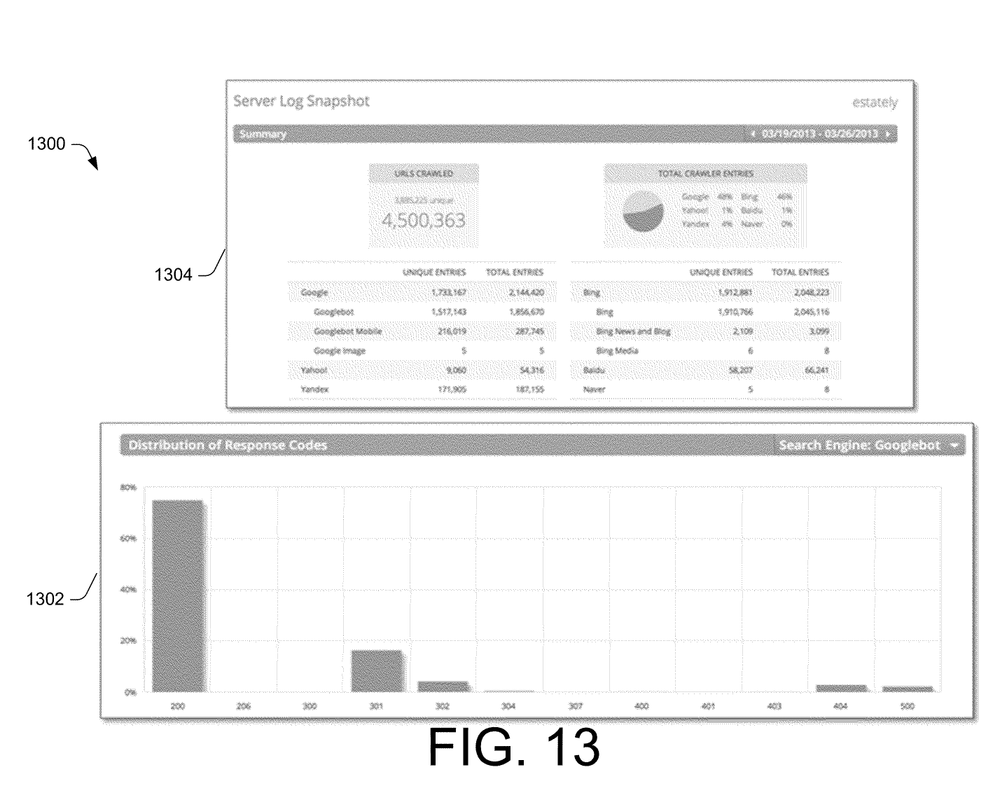

FIG. 13 illustrates an example server status report 1300 generated by the website analyzer 136. The reports 1300 may be generated to show a snapshot of how well each web crawler is indexing a website over a period of time. In one instance, the status report 1300 may show a chart 1302 that displays the percentage distribution of response status code over a predetermined period of time. In another instance, the status report 1300 may show details 1304 on how well each search engine is indexing the website.

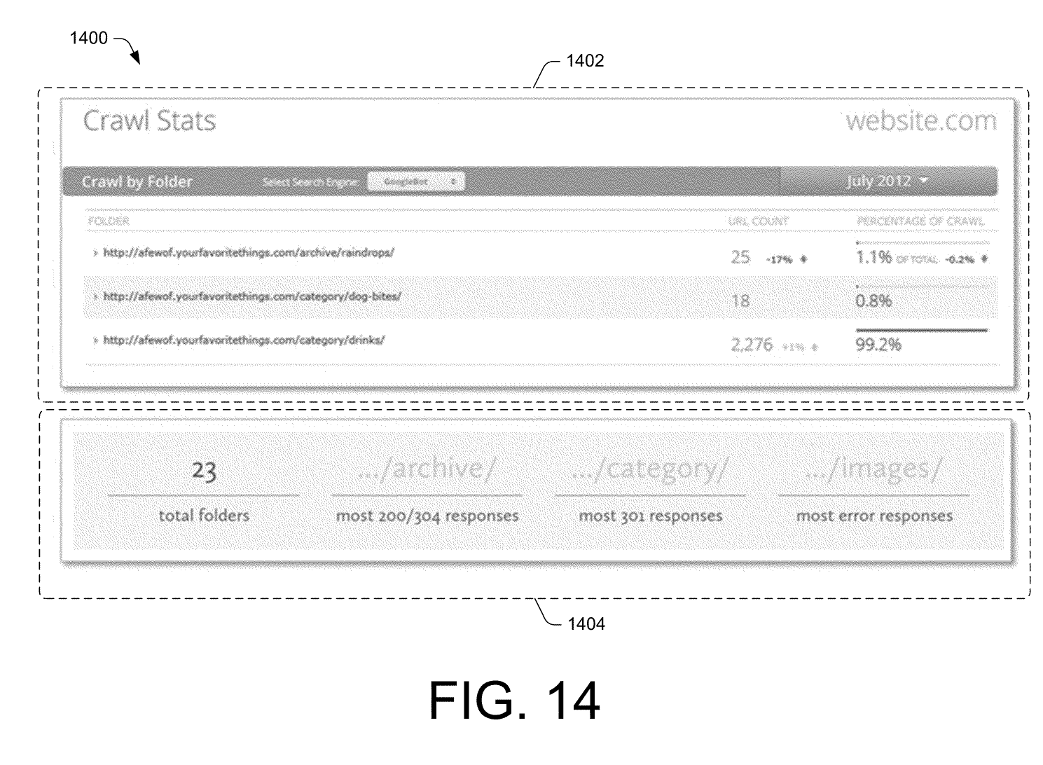

FIG. 14 illustrates an example server status report 1400 generated by the website analyzer 136. The report 1400 may provide statistical data 1402 on the amount of crawls that a web crawler of a search engine devotes to each directory of a website in a time interval. For example, each of the directories may be provided with an actual URL count, i.e., the number of times the web crawler visited the directory. The number of times the web crawler visited a directory may be further presented as a percentage of the total number visits to the website by the web crawler in the report 1400. Thus, according to the report 1400, Googlebot is spending most of its crawling allotment on pages in the “drinks” section of the website.

In some instances, the report 1400 may provide other web crawler statistics 1404 with respect to the directories of the website. For example, the statistics may show that the “archive” directory has the most 200/304 response status codes, the “category” directory has the most 301 response status codes, and the “image directory” has the most error responses.

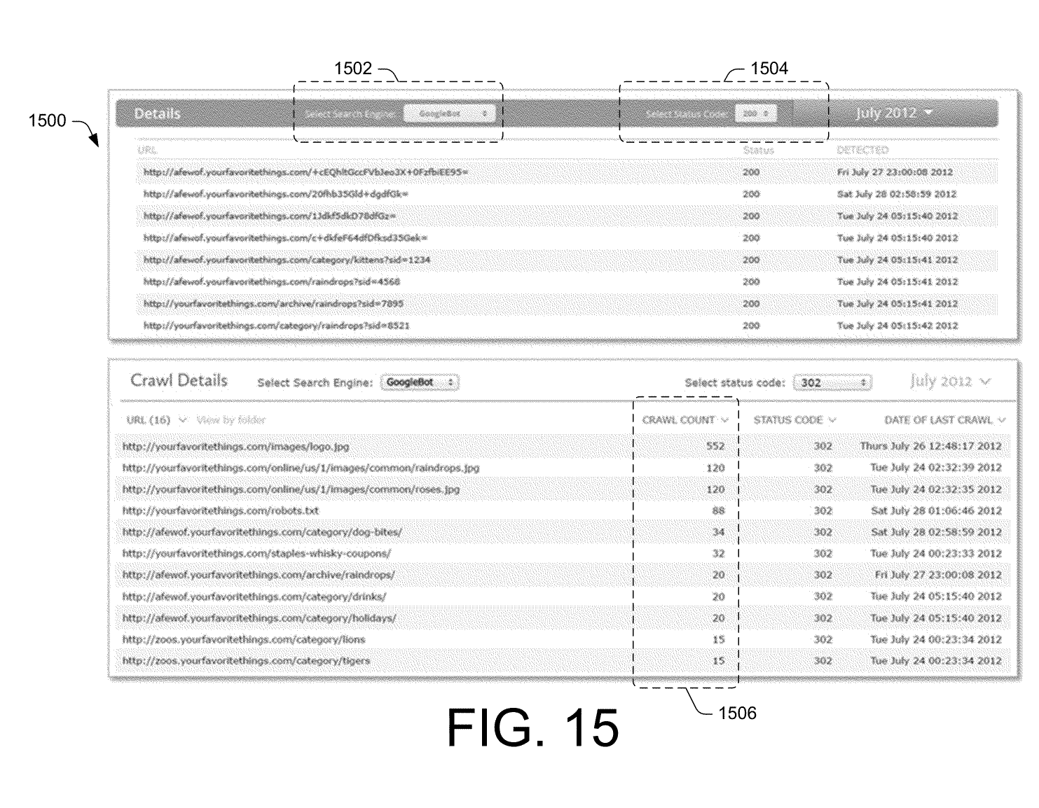

FIG. 15 illustrates an example server status report 1500 generated by the website analyzer 136. The report 1500 may display the URLs of web pages that are visited by the web crawler as filtered by search engine and/or response status code. Along with the URL of each web page, the report 1500 may also show the response status code and the date and time of each visit. In various embodiments, the report 1500 may include user input control 1502 that enables a user to filter the URLs by search engine, and user input control 1504 that enables the user to filter the URLs by response status code. In alternative embodiments, the report 1500 may also show crawl details in a report portion 1506. The report portion 1506 may show the number of times that a web crawler visited each URL in a particular time period.

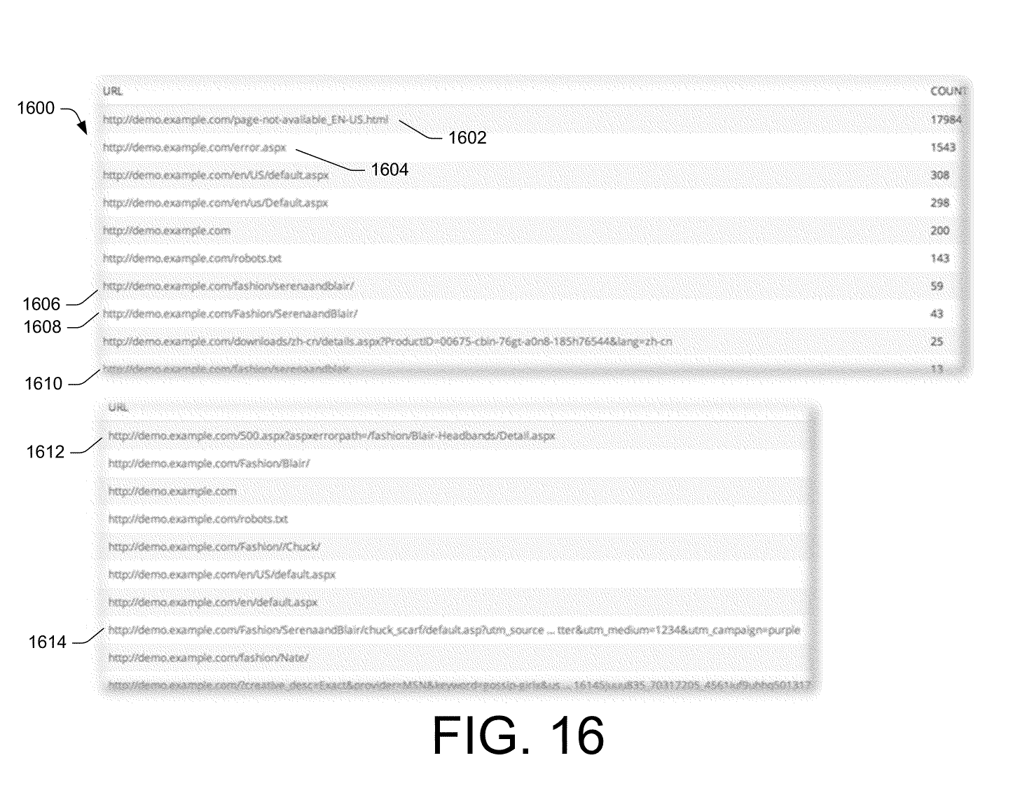

FIG. 16 illustrates an example server status report 1600 generated by the website analyzer 136. The report 1600 display the number of times (count) that a web crawler has visited various web pages of a website in a particular time period. The report 1600 may reveal several problems. For example, the count data shows that the web crawler is spending most of its crawling on the URLs 1602 and 1604, which potentially indicates that the corresponding web pages may be returning the wrong response status code. In another example, the report 1600 may show that there are multiple web pages 1606, 1608, and 1610 with similar URLs being visited by the web crawler. The presence of the multiple web pages 1606, 1608, and 1610 may indicate canonicalization and/or duplication errors within the web pages of the website. In some instances, the report 1600 may indicate other problems. For example, the URL 1612 may have “500” in the URL but is returning a “200” response status code. Further, the report 1600 may show that certain URLs that are designated as being excluded from indexing, such as URL 1614, are being indexed by the web crawler.

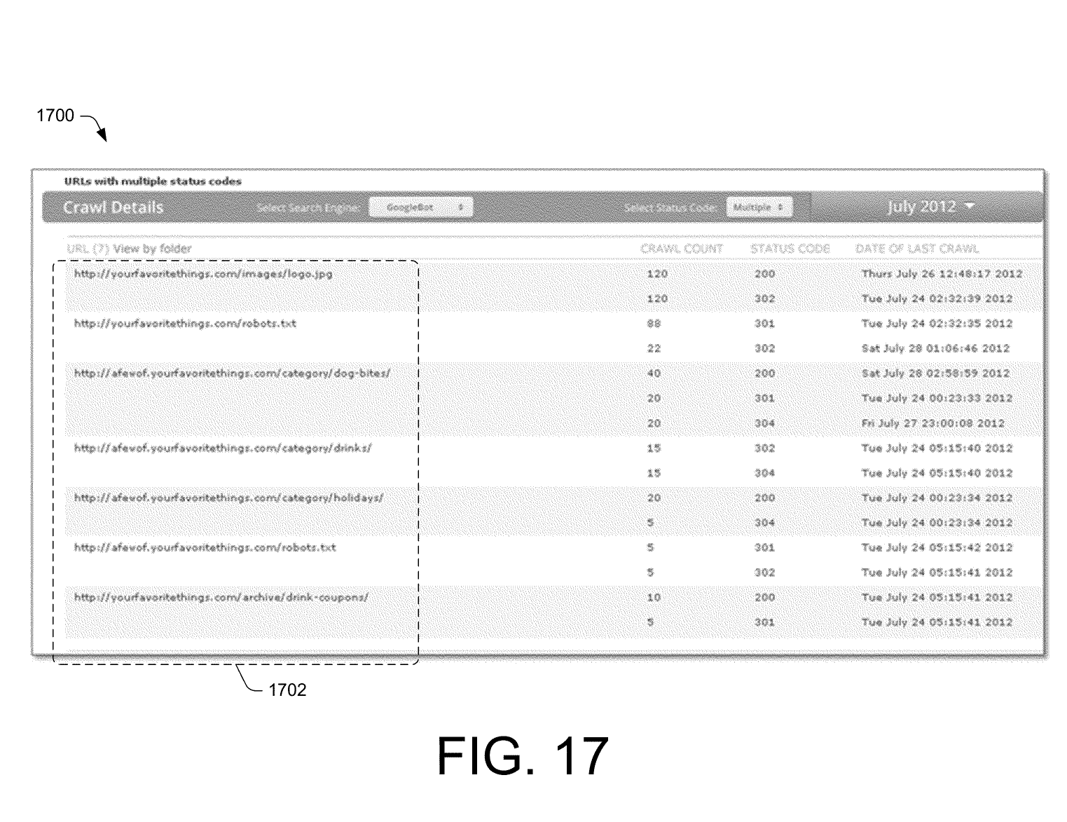

FIG. 17 illustrates an example server status report 1700 generated by the website analyzer 136. The report 1700 may display URLs of a website that returned more than one type of response status code to web crawlers. Such behavior by the servers that host the web pages associated with the URLs may indicate hardware and/or software issues. For example, the servers may have difficulty with load balancing due to one of the servers being configured incorrectly. As shown, each of the URLs 1702 in the report 1700 has more than one type of response status code.

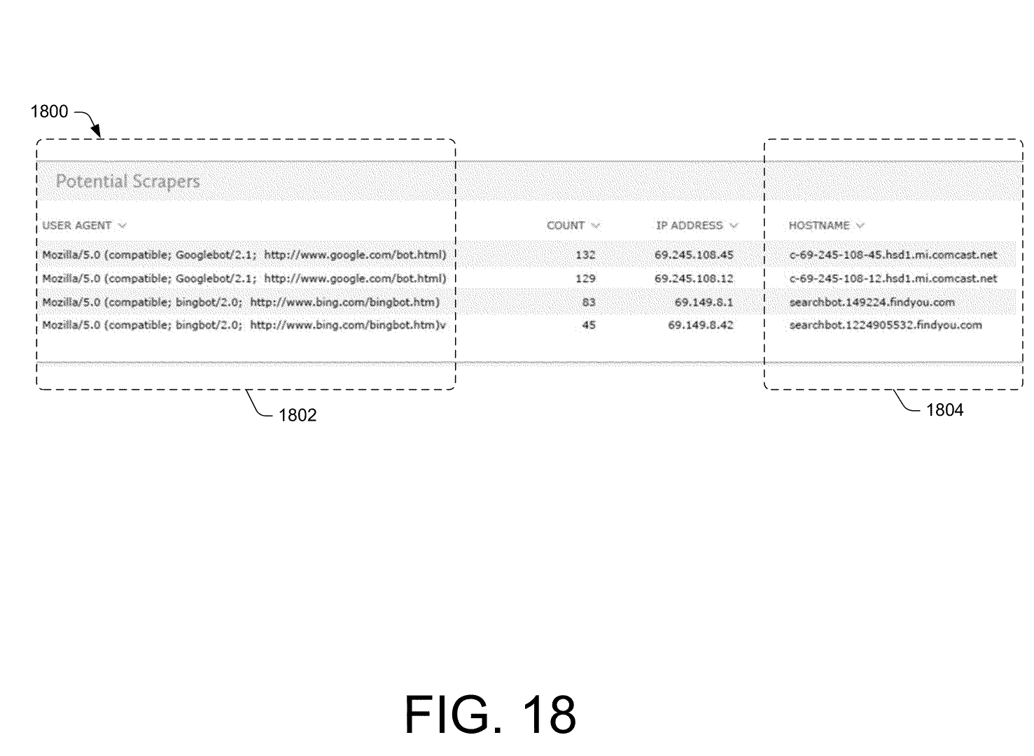

FIG. 18 illustrates an example server status report 1800 generated by the website analyzer 136. The website analysis module 218 of the website analyzer 1336 may have the ability to perform a reverse lookup of agents that present themselves as search engine web crawlers. The reverse lookup of the agents ensures that their host names match their presented identities. When an agent that identifies itself as a search engine web crawler has a host name that actually indicates the agent has a different entity, the agent may be a data scrapper that is spoofing itself as a web crawler. For example, the report 1800 generated by the website analyzer 136 shows sample agents 1802 that have irrelevant host names 1804.

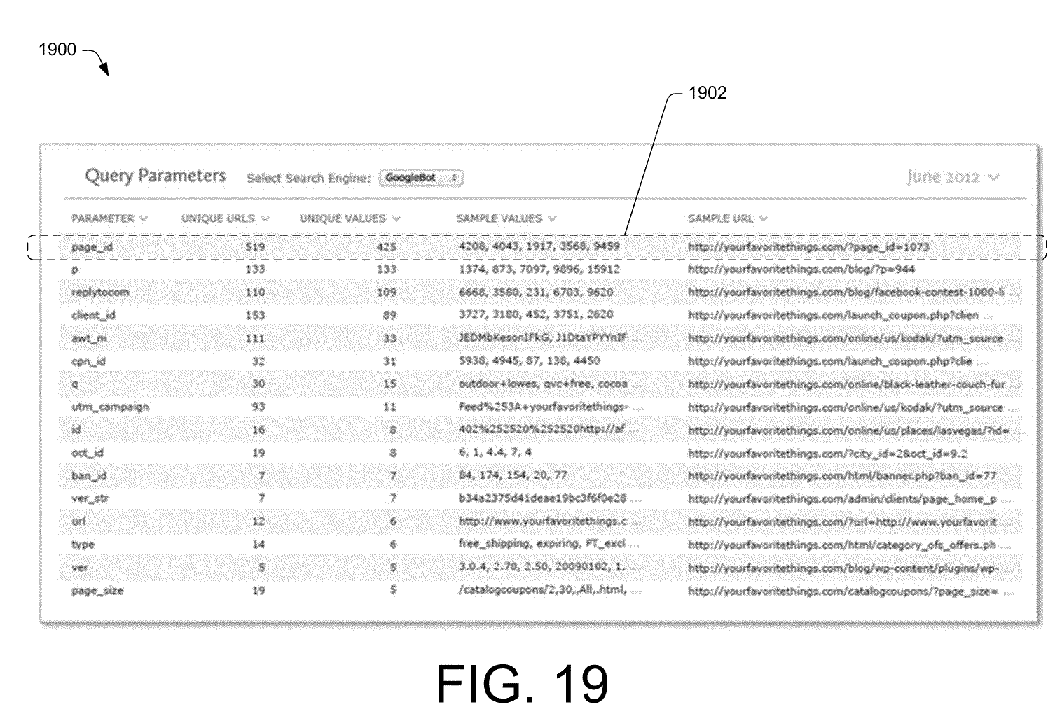

FIG. 19 illustrates an example server status report 1900 generated by the website analyzer 136. In various embodiments, the website analysis module 218 of the website analyzer 136 may extract parameters from the URLs in the server logs. The website analysis module 218 may further generate the report 1900 to show how many times each of the parameters is crawled in a particular time interval, how many URLs contain each parameter, and/or how many unique parameters value are present in the parameters. In some instances, such details in the report 1900 may help reveal unneeded parameters that may be reducing the web crawl efficiencies of the search engine web crawlers. For example, a first entry 1902 of the report 1900 may show that the parameter “page_id” is present in 519 unique URLS, and has 425 unique values. The first entry 1902 further shows some of the sample values for the parameter “page_id” and a sample URL that includes the parameter “page_id.”

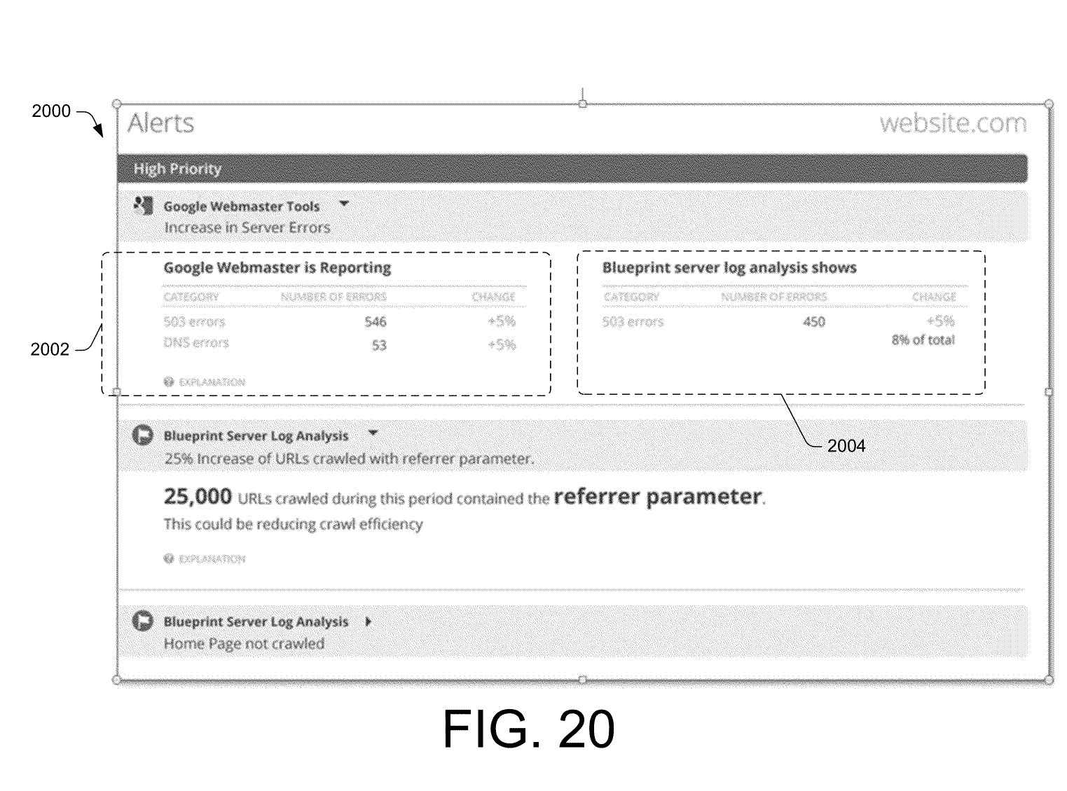

FIG. 20 illustrates an example server status report 2000 generated by the website analyzer 136. In some instances, a search engine may provide server error information, such as the server error information 144, regarding a website. The website analyzer 136 may capture such server error information from the servers of the website. For example, as shown in the report portion 2002, the Google search engine may report that the servers of the website have an increasing amount of particular types of server errors (e.g., 503 errors and DNS errors). Accordingly, the website analysis module 218 of the website analyzer 136 may cross reference the server error information from a search engine with error information from the server logs, such as the server logs 138. Based on the analysis, the website analysis module 218 may provide additional details regarding the server error reported by the search engine. For example, as shown in the report portion 2004, the 503 errors constitute 8% of the total web crawls performed by the Google search engine. Such information may help a website operator of the website to prioritize fixing certain types of errors over fixing other types of errors.

FIG. illustrates an example server status report 2100 generated by the website analyzer 136. As describe with respect to FIG. 20, a search engine may provide server error information regarding a website. For example, as shown in report portion 2102 of the report 2100, a server error message from the search engine may indicate that visitor traffic to a particular web page of the website has decreased significantly. In this instance, by analyzing the server logs of the website, the website analysis module 218 of the website analyzer 136 is able to determine that the cause is a simple redirect (as indicated by the response status code 301) of visits to the particular web page to an alternative web page of the website. In some embodiments, the website analysis module 218 may also have the ability to crawl to the particular web page and confirm that a redirect does occur. Accordingly, the website analysis module 218 may generate a reason message that is displayed in the report portion 2104 of the report 2100. The reason message may alleviate a website operator from investigating the server error information provided by the search engine.

### Illustrative Operations

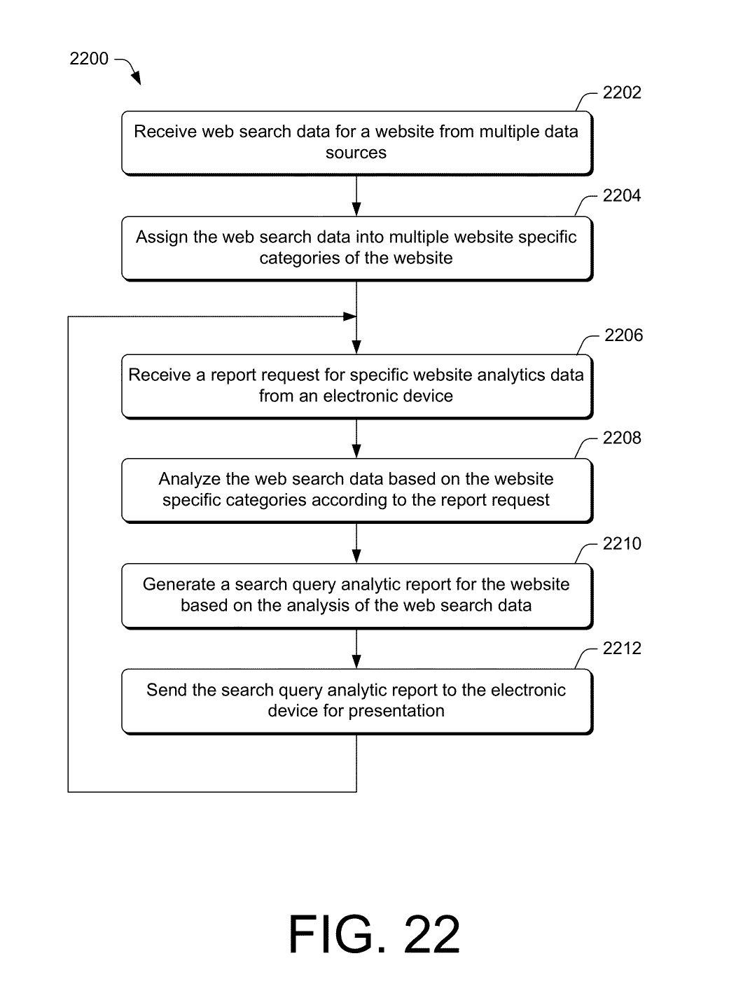

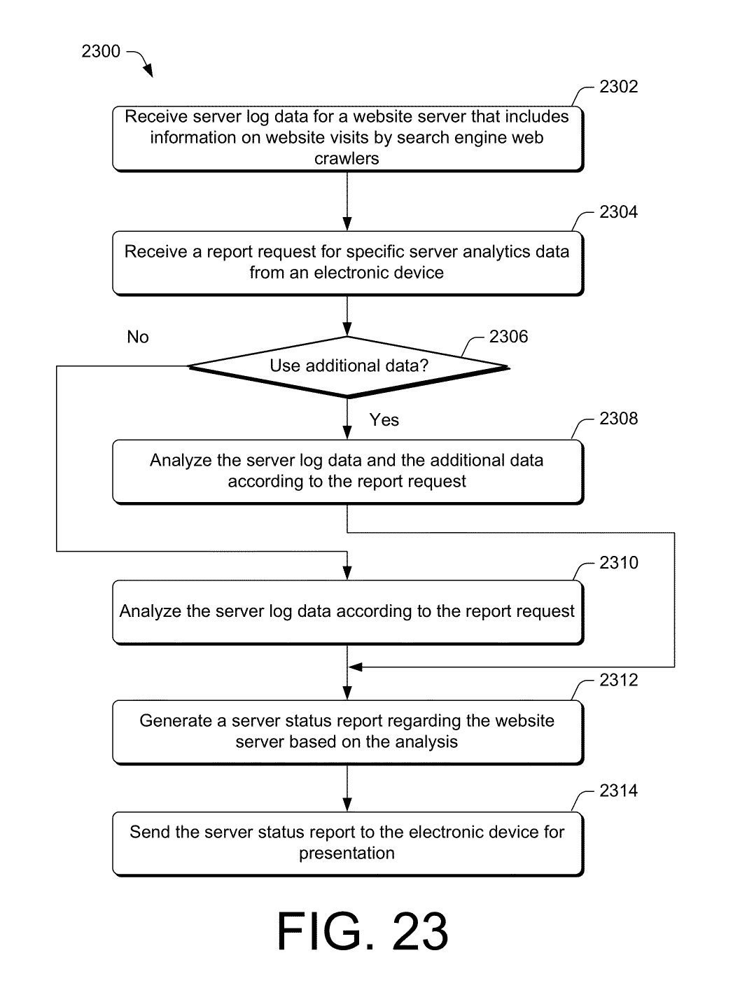

FIGS. 22 and 23 show illustrative processes 2200 and 2300 that respectively performs search query analysis and server log analysis. Each of the processes 2200 and 2300 is illustrated as a collection of steps in a logical flow diagram, which represents a sequence of operations that can be implemented in hardware, software, or a combination thereof. In the context of software, the steps represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described steps can be combined in any order and/or in parallel to implement the process. For discussion purposes, the processes 2200 and 2300 are described with reference to the environment 100 of FIG. 1.

FIG. 22 is a flow diagram of an illustrative process 2200 for providing a search query analytic report based on web search data from multiple data sources. At block 2202, the search data analyzer 124 may receive web search data for a website, such as the website 126, from multiple data sources. The web search data may include web analytics data 112, the webmaster data 114, and/or the keyword research data 116. The web analytics data 112 may be generated by the web analytics tool 118 of the one or more search engines 102. The webmaster data 114 may be generated by the webmaster tool 120 of the one or more search engines 102, and the keyword research data 116 may generated by the keyword research tool 122 of the one or more search engines 102.

At block 2204, the search data analyzer 124 may assign the web search data into a plurality of website-specific categories of the website. The categories may be developed using factors such as the business objectives of a website operator who operates the website, the business processes and practices of the website operator, as well as other data regarding the operations and strategies of the website operator. In various embodiments, the search data analyzer 124 may use classification attributes that are developed for the categories to perform the classification.

At block 2206, the search data analyzer 124 may receive a report request for specific website analytics data from an electronic device, such as the client device 234. The report request may be initiated via a web browser and/or one or more custom applications installed on the electronic device. In other instances, the search data analyzer 124 may have the ability to automatically generate reports without user request.

At block 2208, the search data analyzer 124 may analyze the web search data based on the website-specific categories according to the report request. In various embodiments, the analysis may be performed on web search data that includes keywords in the multiple search queries, search result positions of the website with respect to the multiple search queries, website traffic volume, number of website impressions, website click-through rates, conversions rates, revenues, and/or so forth. The analysis may include the arrangement, graphing, sorting, classification, and/or correlation of the information in the web search data.

At block 2210, the search data analyzer 124 may generate a search query analytic report for the website based on the analysis of the web search data. The search query analytic report may include the specific website analytics data asked for by the report request. For example, a search query analytic report may show the search result positions of a website with respect to keywords that are in the multiple categories of search queries. The search query analytic report may provide information pertaining to the number of impressions, click-through rates, web traffic, and/or other data that are associated with the search result positions. In another example, a search query analytic report may project the expected increase in click-through rate, traffic volume, conversion rate, and/or revenue when the search result position of a website with respect to a particular set of keywords in a category is improved. The search query analytic report may be one of the reports 300-1000 described in FIGS. 3-10.

At block 2212, the search data analyzer 124 may send the search query analytic report to the electronic device. In various embodiments, the search query analytic report may be presented by the electronic device to a user in digital form (e.g., web page, application interface page, etc.) via a web browser and/or one or more custom applications on the electronic device.

FIG. 23 is a flow diagram of an illustrative process 2300 for providing a server status report based on information on website visits by search engine web crawlers. At block 2302, the website analyzer 136 may receive server log data for a website server. In various embodiments, the server log data may include information on website visits by search engine web crawlers. For example, the server logs may include entries that pertain to web crawler visits, in which each entry may shows an identifier of a web crawler, the uniform resource locator (URL) of the web page visited by the web crawler, the time and date of visit, a response status code that is returned regarding the visit.

At block 2304, the website analyzer 136 may receive a report request for specific server analytics data from an electronic device, such as the client device 234. The report request may be initiated via a web browser and/or one or more custom applications installed on the electronic device. In other instances, the website analyzer 136 may have the ability to automatically generate reports without user request.

At decision block 2306, the website analyzer 136 may determine whether the report request calls for the use of additional data. In various embodiments, the additional data may include website analytics data and/or server error information from the one or more search engines 102. Accordingly, if the website analyzer 136 determines that additional data is to be used (“yes” at decision block 2306), the process 2300 may proceed to block 2308. At block 2308, the website analyzer may analyze the server log data and the additional data according to the report request. The analysis may include the arrangement, graphing, sorting, classification, and/or correlation of the information in the server log data and the additional data to determine web page indexing behaviors of each search engine web crawler.

However, if the website analyzer 136 determines that additional does not need to be used (“no” at decision block 2306), the process 2300 may proceed to block 2310. At block 2308, the website analyzer 136 may analyze the server log data according to the report request. The analysis may include the arrangement, graphing, sorting, classification, and/or correlation of the information in the server log data to determine web page indexing behaviors of each search engine web crawler.

At block 2312, the website analyzer 136 may generate a server status report for the website based on the analysis of the server log data and/or the additional data. The server status report may provide information on the web page indexing behaviors of search engines with the respect to the website. For example, the server status reports may identify trends in the amount of errors over time, reveal particular sections of a website (e.g., one or more particular web pages) that are responsible for the errors, pinpoint other causes such as slow server response time, incorrect server configuration parameters, and/or so forth. A report may also indicate difference in the amount of errors encountered by different search engines. The server status reports may be one of the reports 1100-2100 described in FIGS. 11-21.

At block 2314, the website analyzer 136 may send the server status report to the electronic device. In various embodiments, the server status report may be presented in digital form (e.g., web page, application interface page, etc.) by the electronic device to a user via a web browser and/or one or more custom applications on the electronic device.

In summary, the search query analytic reports that are generated in accordance with the various embodiments may assist the website operator in understanding web traffic patterns in relation to the website and develop effective strategies in driving web traffic to the website. Further, the server status reports that are generated in accordance with the various embodiments assist a website in identifying problems that may delay or hinder the proper indexing of web pages stored on a web server.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. One or more computer-readable media storing computer-executable instructions that, when executed, cause one or more processors to perform acts comprising:
receiving web search data for a website from a plurality of data sources,
assigning the web search data into a plurality of website-specific categories of the website;
analyzing the web search data based on the website-specific categories; and
generating a search query analytic report for the website based on analysis of the web search data.

2. The one or more computer-readable media of claim 1, wherein the web search data includes keywords from search queries and search result positions of the website with respect to the search queries, and at least one of click-through rates to the website, impressions of the website, or query count of the website that are associated with the search result positions of the website.

3. The one or more computer-readable media of claim 2, wherein the assigning includes assigning each corresponding set of keywords and at least one of associated search result positions of the website, associated click-through rates to the website, associated number of impressions of the website, or associated query count of the website into a relevant website-specific category of the website, the each corresponding set of keywords being selected from the keywords of the search queries.

4. The one or more computer-readable media of claim 2, wherein the generating includes generating the search query analytic report to display, for each of one or more website-specific categories, a trend line over time for at least one of a visitor traffic volume, a category ranking, a number of impressions, a click-through rate, and a query count.

5. The one or more computer-readable media of claim 4, wherein the generating includes generating the search query analytic report to display an average click-through rate for each search result position of the website in multiple website-specific categories in a time interval.

6. The one or more computer-readable media of claim 2, wherein the generating includes generating the search query analytic report to display a projected change in at least one of a visitor traffic volume, a click-through rate, a number of conversions, and revenue per conversion based on at least on a projected change in a search result position of the website in a website-specific category.

7. The one or more computer-readable media of claim 6, wherein the generating includes generating the search query analytic report based on a projected change in the search result position of the website in the website-specific category, a change in a conversion rate for the website-specific category, and a change in revenue for the website-specific category.

8. The one or more computer-readable media of claim 2, wherein the generating includes generating the search query analytic report to display at least one of a change in visitor traffic volume, a change in a number of impressions, a change in click-through rate, a change in average search result position, and a change in query count in a specific time period for each of one or more web specific categories in a time interval.

9. The one or more computer-readable media of claim 1, wherein the web search data includes at least one of web analytics data from a web analytics tool of a search engine, webmaster data from a webmaster tool of the search, and keyword research data from a keyword research tool of the search engine.

10. The one or more computer-readable media of claim 9, wherein the generating includes generating the search query analytic report based on the webmaster data and the keyword research data to display at least one of one or more particular keywords of search queries relevant to the website that are missing from the web analytics data, a count of the one or more particular keywords, or a percentage of the one or more particular keywords in relation to a total number of keywords that are relevant to the website.

11. A computer-implemented method comprising:
receiving web search data for a website from a plurality of data sources, the web search data including at least one of web analytics data from a web analytics tool of a search engine, webmaster data from a webmaster tool of the search, and keyword research data from a keyword research tool of the search engine;
assigning the web search data into a plurality of website-specific categories of the website;
receiving, from an electronic device, a report request for specific website analytics data that is derived from the web search data;
analyzing the web search data based on the website-specific categories according to the report request;
generating a search query analytic report for the website based on analysis of the web search data, the search query analytic report including the specific website analytics data; and
sending the search query analytics report to the electronic device for presentation.

12. The computer-implemented method of claim 11, wherein the web search data includes keywords from search queries and search result positions of the website with respect to the search queries, and at least one of click-through rates to the website, impressions of the website, query count of the website that are associated with the search result positions of the website.

13. The computer-implemented method of claim 11, wherein the assigning includes assigning a corresponding set of keywords and at least one of associated search result positions of the website, associated click-through rates to the website, associated number of impressions of the website, associated query count of the website into each website-specific category of the website, each corresponding set of keywords being selected from the keywords of the search queries.

14. A system, comprising:
one or more processors; and
one or more modules stored in memory and executable by the one or more processors to:
receive server log data for a website server that includes information on website visits by one or more web crawlers of search engines;
analyze at least the server log data to determine web page indexing behaviors of the one or more web crawlers with respect to web pages of the website based on responses of the website server to the web crawlers; and
generate a server status report for the website based on analysis of at least the server log data, the server status report disclosing web page indexing behaviors of at least one search engine.

15. The system of claim 14, wherein the server log data includes an identifier of a web crawler that visited the website server, a uniform resource locator (URL) of the web page visited by the web crawler, a time and a date of visit, a response status code that is returned by the website server regarding the visit.

16. The system of claim 14, wherein the one or more modules are further executable by the one or more processors to generate the server status report to display a proportion or a correlation of successful web page indexing by the one or more web crawlers to unsuccessful web page indexing by the one or more web crawlers over a period of time.

17. The system of claim 14, wherein the one or more modules are further executable by the one or more processors to generate the server status report to display a percentage distribution of server status response codes that correlate to successful and unsuccessful web page indexing by a web crawler over a time interval.

18. The system of claim 14, wherein the one or more modules are further executable by the one or more processors to generate the server status report to display at least one of:
an amount of visits by a web crawler to each web page directory stored on the website server;
an identifier of a directory on the website server that generates a most amount of errors;
a uniform resource locator (URL) of a web page that is most visited by the web crawler;
a URL of a web page that cause the website server to return multiple different response status codes to the web crawler; and
a parameter and a parameter value of a URL that is visited by the web crawler.

19. The system of claim 14, wherein the one or more modules are further executable by the one or more processors to:
perform a reverse lookup of a host name that belongs to an agent presenting an identity of a web crawler; and
generate the server status report to display at least the host name of the agent in response to a discrepancy between the host name and the identity of the web crawler presented by the agent.

20. The system of claim 14, wherein the one or more modules are further executable by the one or more processors to compare the server log data and server error information received from a search engine, and to generate the server status report to display details that are unavailable in the server error information.
